(19) United States
(12) Patent Application Publication
(10) Pub. No.: US 2011/0178446 A1
(43) Pub. Date: Jul. 21, 2011

(54) AMBULATORY DEVICE

(76) Inventor: Anthony V. Benenati, Washington Twp, MI (US)

(21) Appl. No.: 13/005,248

(22) Filed: Jan. 12, 2011

Related U.S. Application Data
(60) Provisional application No. 61/295,318, filed on Jan. 15, 2010.

(51) Int. Cl. A61H 3/00

(52) U.S. Cl. 601/34

(57) ABSTRACT

An ambulatory device adapted for attachment to the thigh and shin of a human leg. The ambulatory device includes a leg splint having an elongated thigh support and an elongated shin support extending outwardly from the thigh support at an obtuse angle. The thigh support is constructed of a rigid material and includes a front section adapted to flatly abut against the front of the thigh and spaced apart side sections adapted to abut against opposite sides of the human thigh. A fastener secures the thigh support to the thigh against movement while, similarly, a second fastener secures the shin support to the shin of the leg. An elongated leg has one end attached to and extending perpendicularly outwardly from the shin support while a foot plate is attached to the other end of the leg.

### CROSS REFERENCE TO RELATED APPLICATIONS

This application claims priority of U.S. Provisional Patent Application Ser. No. 61/295,318 filed Jan. 15, 2010, which is incorporated herein by reference.

### BACKGROUND OF THE INVENTION

I. Field of the Invention

The present invention relates generally to medical devices and, more particularly, to an ambulatory device.

II. Description of Related Art

Following foot surgery a patient typically cannot place his or her weight on the foot that was the subject of the surgery during the patient's recovery period. This recovery period, moreover, may extend over a period of weeks. Rather, during that recovery period the patient must keep all weight off of the foot in order to allow the foot to heal properly.

Consequently, it has been the prior practice for such patients to confine such patients to wheelchairs during the recovery period. Such wheelchairs, however, are bulky, expensive, difficult to transport from one location to the other and, for many people, difficult to operate. Furthermore, many homes are simply not constructed to be wheelchair accessible or wheelchair friendly. This, in turn, further increases the difficulty of utilizing a wheelchair following foot surgery.

There are other medical situations in which it is necessary to maintain foot off loading. For example, it is often necessary for diabetic and ulcer management as well as planters foot to maintain foot off loading. Likewise, treatment of foot and ankle fractures also often require foot off loading.

### SUMMARY OF THE PRESENT INVENTION

The present invention provides an ambulatory device for use by a patient following foot surgery which overcomes all of the above-mentioned disadvantages of the previously known wheelchair use.

In brief, the ambulatory device of the present invention comprises a leg splint having an elongated thigh support and an elongated shin support. Preferably, the leg splint is of a one piece construction and is constructed of a rigid material, such as plastic.

The thigh support includes a front section adapted to abut against the front of a thigh and spaced apart side sections adapted to abut against the opposite sides of the human thigh. A first fastener having a strap and a thigh pad secures the thigh support to the human thigh so that the thigh support surrounds at least a portion of the thigh and prevents movement between the thigh and the thigh support.

Similarly, a second fastener having a strap and a calf pad secures the shin support to the shin of the human. Since the longitudinal axis of the shin support is oblique to the thigh support, the shin support supports the human foot at a position above ground level when the person is standing.

An elongated leg has one end attached to and extends downwardly from the shin support when the person is standing. The length of the elongated support is preferably adjustable to accommodate persons of different heights. A foot plate is also attached to the other end of the leg.

In use, the ambulatory device is secured to the person's thigh and shin by the first and second straps and their associated thigh and calf pads. In doing so, movement between the ambulatory device and the person's thigh and shin is prevented. This, in turn, provides a stable attachment to the person's leg so that the person may walk in a normal fashion by utilizing the elongated leg and foot plate as an artificial leg while maintaining the person's real foot in an elevated position above the ground support surface.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a side view illustrating a preferred embodiment of the invention;

FIG. 2 is an exploded side view illustrating the preferred embodiment of the invention;

FIG. 3 is a perspective view illustrating the preferred embodiment of the invention and with parts removed for clarity; and

FIG. 4 is a side view illustrating a portion of the preferred embodiment of the invention and with parts removed for clarity.

### DETAILED DESCRIPTION OF A PREFERRED EMBODIMENT OF THE PRESENT INVENTION

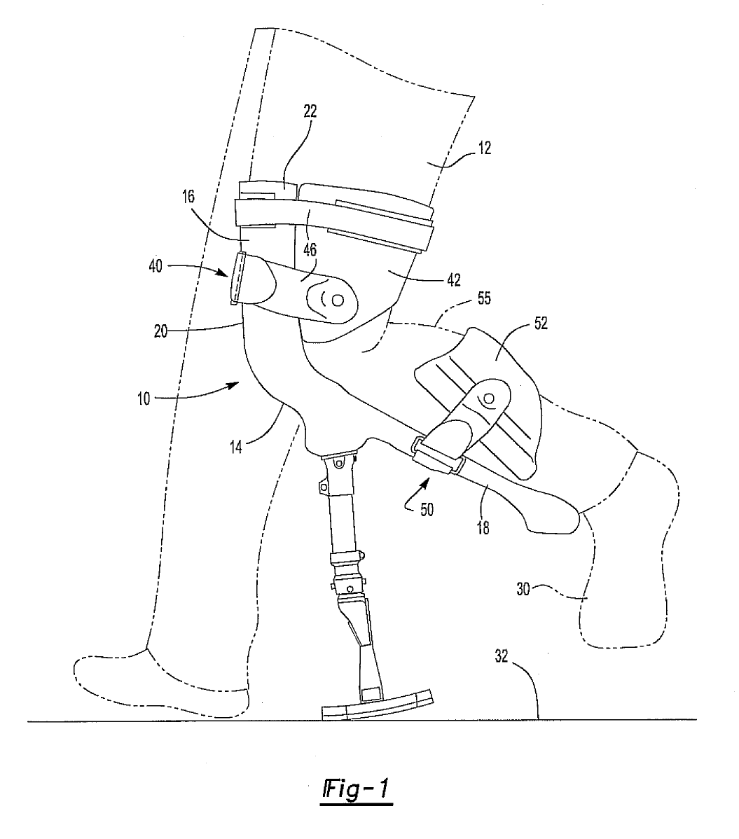

With reference first to FIGS. 1-3, a preferred embodiment of an ambulatory device 10 in accordance with the present invention is shown attached to the leg 12 of a human. The ambulatory device 10 includes a leg splint 14 having an elongated thigh support 16 and an elongated shin support 18.

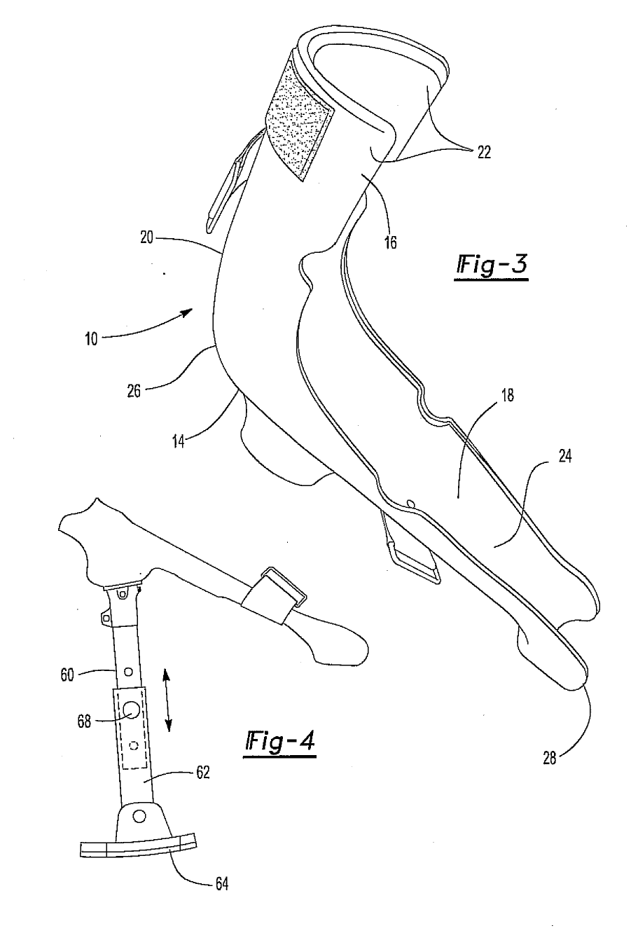

As best shown in FIGS. 1 and 3, the thigh support 16 includes a front section 20 adapted to flatly abut against the front of the thigh of the leg 12 as well as two spaced apart side sections 22. These side sections 22 are adapted to abut against opposite sides of the thigh so that the front of the thigh is at least partially surrounded by the thigh support 16.

Similarly, the shin support 18 includes a concave surface 24 adapted to abut against the front of the person's shin. The shin support 18, furthermore, extends from the knee 26 to a free end 28 short of the person's ankle.

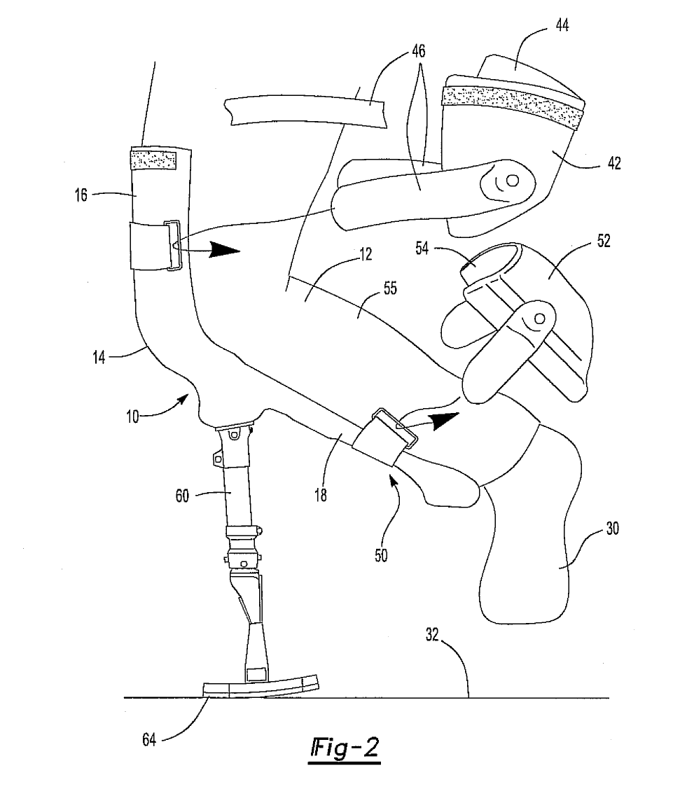

The longitudinal axis of the thigh support 16 intersects the longitudinal axis of the shin support 18 at the knee preferably at an obtuse or perpendicular angle. Consequently, with the ambulatory device 10 positioned on the leg as shown in FIGS. 1 and 2 and with the person standing, the person's foot 30 is positioned above the ground surface 32.

With reference still to FIGS. 1 and 2, a first fastener 40 securely attaches the thigh support 16 to the person's thigh to prevent not only forward and rearward movement of the person's thigh relative to the ambulatory device 10, but to also prevent lateral movement between the person's thigh and the ambulatory device 10. In the preferred embodiment, the fastener 40 comprises a rear pad 42 having a concave surface 44 which conforms to and abuts against the rear of the person's thigh. The thigh pad 42 is secured to the thigh support 16 by one or more elongated straps 46 so that the person's thigh is sandwiched in between the thigh support 16 and the thigh pad 42. Preferably the straps 46 utilize a hook-and-pile attachment so that the person's thigh can be firmly and adjustably sandwiched in between the thigh pad 42 and the thigh support 16.

Similarly, a second fastener 50 securely fastens the shin support 18 to the person's leg. The second fastener 50 includes a calf pad 52 with a concave surface 54 which conforms to and flatly abuts against the person's calf 55. One or more elongated straps 56 preferably utilizing hook-and-pile fasteners are used to firmly and adjustably secure the calf pad 52 to the shin support 18 so that the person's calf 55 is sandwiched in between the calf pad 52 and shin support 18.

The combination of the thigh support 22 and thigh pad 42 not only firmly attaches the thigh support 22 to the person's thigh, but also provides lateral support around the sides of the person's thigh and thus prevents movement of the person's thigh relative to the thigh support 16. Similarly, the concave shape of the calf pad 52 in conjunction with the concave shape of the shin support 18 not only sandwiches the person's lower leg in between the calf pad 52 and shin support 18, but also provides lateral support against movement of the person's lower leg relative to the shin support 18. As such, the person's entire leg is locked to the ambulatory device 10 against movement.

Preferably, the thigh support 16 and shin support 18 are of a one piece plastic construction. However, the thigh support 16 and shin support 18 may be made of multi piece construction without deviation from the spirit or scope of the invention. For example, in some cases it may be desirable to provide an angular adjustment in between the thigh support 16 and the shin support 18.

With reference now particularly to FIGS. 2 and 4, an elongated leg 60 has one end 62 rigidly secured to the shin support 18 so that the leg 60 extends downwardly from the shin support 18 and generally parallel to the axis of the thigh support 16. A foot plate 64 is then secured to the lower end of the leg 60 by any conventional means so that the leg 60 and foot plate 64 are firmly attached to the shin support 18.

As shown in FIG. 4, the leg 60 preferably includes a pair of telescoping tubes 62 and 64 which provide length adjustment for the leg 60 in order to accommodate different patients of different heights. The telescoping tubes of the leg 60 may be secured together at a user adjusted position by any conventional means, such as a clamp 68.

With the ambulatory device 10 attached to the person's leg in the previously described fashion, the person is able to walk in a semi normal fashion in which the leg 60 and foot plate 64 provide the function of the person's lower leg and foot. At the same time, the person's foot 30 is elevated above the ground support surface thus protecting the foot during the surgical recovery period.

From the foregoing, it can be seen that the present invention provides a simple and yet unique ambulatory device which is particularly useful for use after foot surgery. Having described my invention, however, many modifications thereto will become apparent to those skilled in the art to which it pertains without deviation from the spirit of the invention as defined by the scope of the appended claims.

I claim:

1. An ambulatory device adapted for attachment to the thigh and shin of a human leg, said ambulatory device comprising:
a leg splint having an elongated thigh support and an elongated shin support,
said thigh support being constructed of a rigid material and having a front section adapted to abut against the front of the thigh and spaced apart side sections adapted to abut against opposite sides of the human thigh,
a first fastener which detachably secures said thigh support against movement to the human thigh,
a second fastener which detachably secures said shin support to the shin of the leg,
a longitudinal axis of said thigh support extending obliquely to a longitudinal axis of said shin support,
an elongated leg having one end attached to and extending substantially outwardly and downwardly from said shin support, and
a foot plate attached to the other end of said leg.

2. The device as defined in claim 1 wherein said thigh support is a one piece construction.

3. The device as defined in claim 1 wherein said shin support is a one piece construction.

4. The device as defined in claim 1 wherein said thigh support and said shin support are of a one piece construction.

5. The device as defined in claim 4 wherein said thigh support and said shin support are constructed of a plastic material.

6. The device as defined in claim 1 wherein said first fastener comprises a strap.

7. The device as defined in claim 6 wherein said first fastener comprises a thigh pad having a concave surface which abuts against the rear of the thigh.

8. The device as defined in claim 7 wherein said strap attaches said thigh pad to said thigh support.

9. The device as defined in claim 8 wherein said strap uses a hook-and-pile fastener.

10. The device as defined in claim 1 wherein said second fastener comprises a strap.

11. The device as defined in claim 10 wherein said first fastener comprises a calf pad having a concave surface which abuts against the rear of the calf.

12. The device as defined in claim 11 wherein said strap attaches said thigh pad to said thigh support.

13. The device as defined in claim 12 wherein said strap uses a hook-and-pile fastener.

14. The device as defined in claim 1 and comprising means for adjusting the length of said leg.

15. The device as defined in claim 14 wherein said adjusting means comprises at least two telescoping tubes and a clamp for securing said tubes together at an adjusted position.

16. The device as defined in claim 1 wherein said leg extends in a direction substantially parallel to the axis of said thigh support.
